(19) United States
(12) Patent Application Publication
(10) Pub. No.: US 2003/0101087 A1
(43) Pub. Date: May 29, 2003

(54) Lease rent optimizer revenue management system

(75) Inventors: Thomas M. Walker, Fayetteville, GA (US); Donald Davidoff, Fayetteville, GA (US); Ahmet Kuyumeu, Smyrna, GA (US); Nancy Pyron, Smyrna, GA (US); Jeff Horak, Woodstock, GA (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Manugistics Atlanta, Inc.

(21) Appl. No.: 09/984,642

(22) Filed: Oct. 30, 2001

Related U.S. Application Data
(60) Provisional application No. 60/244,271, filed on Oct. 30, 2000.

(51) Int. Cl. G06F 17/60

(52) U.S. Cl. 705/10

(57) ABSTRACT

The present invention provides a Lease/Rent Optimizer (LRO) for helping property management companies to forecast and analyze market demand and unit availability, as well as to set leasing agreements based on dynamically measured consumer demand. The LRO takes into account customer preferences, market conditions, and competitive behavior. The system optimally applies user-defined business rules to provide market-specific flexibility in combining base rents and concessions to consumers. By forecasting demand for different unit types and lease terms, then using those forecasts to ensure that inventory is optimally positioned to satisfy demand, the LRO is designed to enhance overall revenue contribution from new and renewing leases. Conversely, these features benefit customers by helping them find the unit types and lease terms they need when they need them by better matching rental unit supplies to demand. The LRO provides sophisticated decision support so that property managers can look beyond comparatively static rules of thumb and past experience to set rental rates. Even when management recognizes the need for repricing, the establishing of new prices involves another application of static rules and gut feel that can result in too little or too much change.

### RELATED APPLICATIONS

This application claims priority from U.S. Provisional Application Serial No. 60/244,271, filed Oct. 30, 2000, the disclosure of which is hereby incorporated by reference in its entirety.

### FIELD OF THE INVENTION

The present invention generally relates to a lease management system that collects and processes data related to multi-family housing units, such as apartment complexes and communities, and then uses this data to provide recommendations for revenue maximizing rents.

### BACKGROUND OF THE INVENTION

A primary challenge for a property management company is to maximize revenues from new and renewal leases. Under pressure to increase revenues from operations, property management companies face extremely complex issues of pricing and capacity allocation. Multi-family units are large fixed assets whose single greatest liability is vacancy cost. Units must not be allowed to run vacant if suitable demand for them exists, but attempting to maximize revenue means more than maximizing occupancy. In fact, a property manager's products are not units, but rather a combination of timing and a balancing of supply and demand. Successfully meeting this complex pricing challenge is simplified by decision-support tools that apply differential pricing strategies and the smart allocation of capacity.

To maximize revenues, the property manager needs to precisely forecast and analyze market demand and unit availability. Likewise, the property manager needs to set lease prices based on measuring dynamic consumer demand. To achieve these goals, the property manager should calculate the economic value of each unit type in the marketplace and determine the optimal effective base rents as well as rents for move-ins and renewals. The property manager also preferably forecasts rental demand during different time periods, as well as regularly re-optimizes rents in response to changing demand, availability, and market conditions. Moreover, a property manager needs to perform these tasks each day, every day, while continuing to effectively serve customers. In addition, a property management company generally desires to institutionalize market knowledge in order to become less dependent on individual managers' skills.

Therefore, there is a need for a system and method to allow property management companies to match rental supply and demand to enhance revenue and better satisfy customers.

### SUMMARY OF THE INVENTION

In response to this and other needs, the present invention provides a Lease/Rent Optimizer (LRO) for helping property management companies to forecast and analyze market demand and unit availability, as well as to set leasing agreements based on dynamically measured consumer demand. The LRO takes into account customer preferences, market conditions, and competitive behavior. The system optimally applies user-defined business rules to provide market-specific flexibility in combining base rents and concessions to consumers. By forecasting demand for different unit types and lease terms, then using those forecasts to ensure that inventory is optimally positioned to satisfy demand, the LRO is designed to enhance overall revenue contribution from new and renewing leases. Conversely, these features benefit customers by helping them find the unit types and lease terms they need when they need them by better matching rental unit supplies to demand.

The LRO provides sophisticated decision support so that property managers can look beyond comparatively static rules of thumb and past experience to set rental rates. Even when management recognizes the need for repricing, the establishing of new prices involves another application of static rules and gut feel that can result in too little or too much change. The LRO helps the user eliminate such guesswork by forming and updating up-to-the-minute statistics and historical observations that may be used to forecast a picture of future supply and demand conditions. The competitive information process calculates the economic value of each unit category in the marketplace, and its pricing calculations estimate the magnitude of change in demand that will result from any specific changes in rents. The LRO then recommends optimal rents for each unit type and lease term, for both new leases and renewals, helping to deliver enhanced revenue.

Overall, the LRO directly addresses the question of what a property management company should charge for products in order to help capture more revenue. Specifically, the LRO uses the power of computers to systematize the forecasting process, helping to prevent other pressing management concerns from delaying or preventing this crucial function. The LRO dynamically adjusts to changing market conditions and makes explicit, optimal pricing recommendations by unit type and lease term to help a property management company to translate supply and demand data clearly into action. The LRO also embeds a disciplined process for enhancing revenues in a property management company to leverage the skill and experience of property managers, even if those managers leave the property management company.

The LRO sets lease rates to help increase revenue by responding to forecasted future supply and demand conditions, not past conditions. The LRO further addresses current competitor actions according to the forecasted impact of these actions on supply and demand. The LRO also addresses vacancy costs and provides intelligence about supply, demand, and pricing throughout the organization.

The optimization of rents and lease terms helps enable increases in top-line revenues and satisfies market demand. At the same time, decision support and management reporting improves the property management operations. Also, the LRO has a flexible configuration that accommodates different community types and market conditions while daily re-forecasting and optimization allow the LRO to adapt quickly to changing market conditions.

In one embodiment, the LRO also includes a web-enabled user interface to allow convenient accessibility and positioning via the Internet or other distributed network. This embodiment further allows for the automated collection of rental data through the use of data mining techniques such as programmed searchers.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIG. 1 illustrates a block diagram of a system to facilitate lease rent optimization in accordance with embodiments of the present invention;

FIG. 2 represents a data structure used in the system of FIG. 1 and the method of FIGS. 2-11; and

FIGS. 3-11 illustrate flow charts depicting steps in a method to facilitate lease rent optimization in accordance with embodiments of the present invention.

### DETAILED DESCRIPTION OF THE PREFERRED EMBODIMENTS

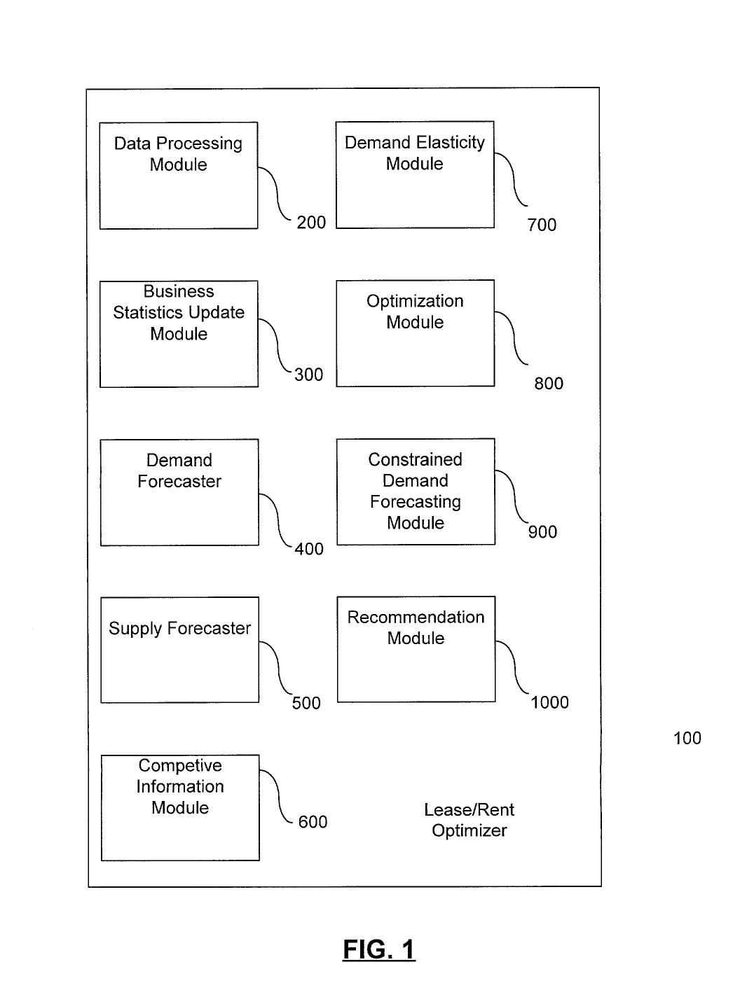

As generally illustrated in FIG. 1, the present invention provides a Lease Rent Optimizing System (hereinafter “LRO”) 100 that can be utilized as a multi-family housing revenue management system to maximize the revenue from multi-family housing units such as apartment complexes and communities. The LRO System 100 forecasts demand for different unit types and lease terms, then uses those forecasts to recommend changes in monthly effective rent. The system 100 then applies community-level business rules to display the recommendations as a combination of base rents and concessions. The system 100 forms the recommendations on the basis of lease type (e.g., new vs. renewal), unit type, time, lease term, forecasted demand and unit availability.

Returning to FIG. 1, the LRO 100 may have various forecasting and optimization modules, including but not limited to:

a Data Pooling Processing Module 200 to manipulate, store, and use data;

a Business Statistics Update Module 300 to keep business statistics up-to-date based on recent activity;

a Demand Forecaster 400 to utilize these business statistics and historical observations to create the final demand forecast;

a Supply Forecaster 500 to capture most recent inventory information and early termination adjustments;

a Competitive Information Module 600 to calculate a reference rent that establishes economic value of each unit category in the marketplace, and a optimizable rent that is computed from the reference rent after removing the property preparation and vacancy costs;

a Demand Elasticity Module 700 to estimate magnitude of demand change in response to rent change;

an Optimization Module 800 to identify optimal effective base rents of move-ins and renewals;

a Constrained Demand Forecasting Module 900 to report demand that is to be accepted; and

a Recommendation Module 1000 to report optimal rents for each unit type as base rent/concession combinations.

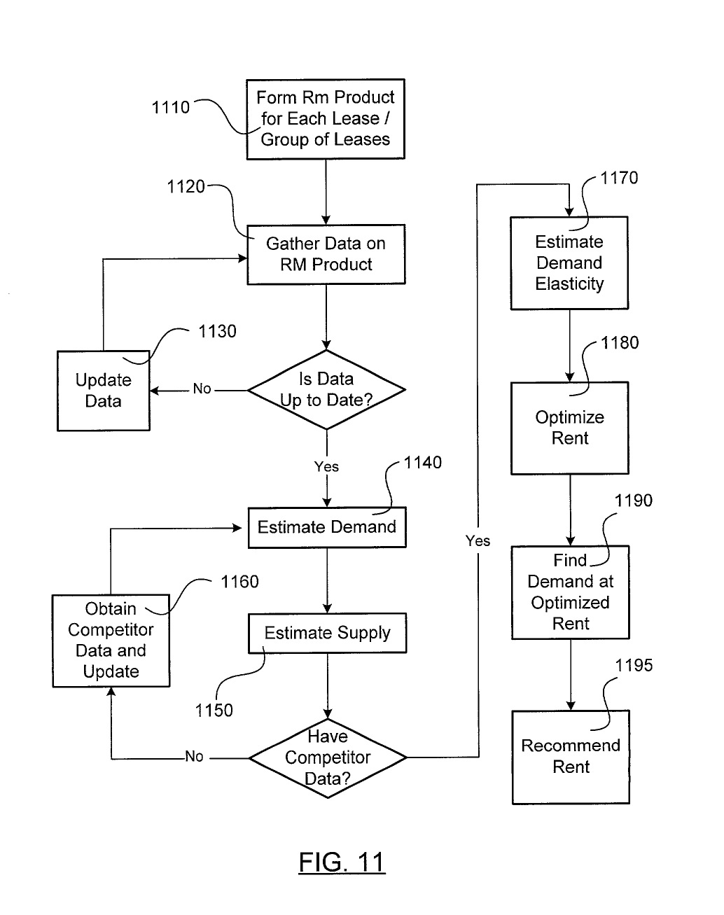

In the LRO 100, the components 200-1000 cooperate to gather and process data. This data is then used to forecast various market conditions. The LRO 100 then uses the forecasts to form rent recommendations in view of preferences established by the user. The function and operation of each of the components is now described in greater detail. The operation of the LRO 100 is summarized in FIG. 11.

Acronymns

The following are acronyms used in this document:

| | |
|---|---|
| CP | Competitor |
| CV | Coefficient of Variation |
| DL | Days Left |
| EP | Epoch Point |
| GPU | Guests Per Unit |
| LNR | Lease Type N or R |
| LT | Lease Term |
| LTC | Lease Term Category |
| MAE | Mean Absolute Error |
| MSE | Mean Squared Error |
| MIW | Move-in Week |
| MOW | Move-out Week |
| NM | Number of Months |
| MT | Month Type (i.e., Jan, Feb, etc.) |
| MS | Market Segment |
| N | New Market Segment |
| R | Renewal Market Segment |
| RM | Revenue Management |
| UC | Unit Category |
| WK | Week |
| WT | Week Type (B: Beginning, M: Middle, E: End) |

Data Types

The LRO 100 uses and stores various types of data in optimizing rent revenues. The foundation of an automated Revenue Management process is a Revenue Management or “RM” Product. A RM product is the most discrete, controllable inventory unit of a revenue management system. The RM product is used to uniquely define a lease and is analogous to stock keeping units (SKU's) used to inventory products. The LRO 100 forecasts and optimizes at the RM product level in step 1110 in FIG. 11.

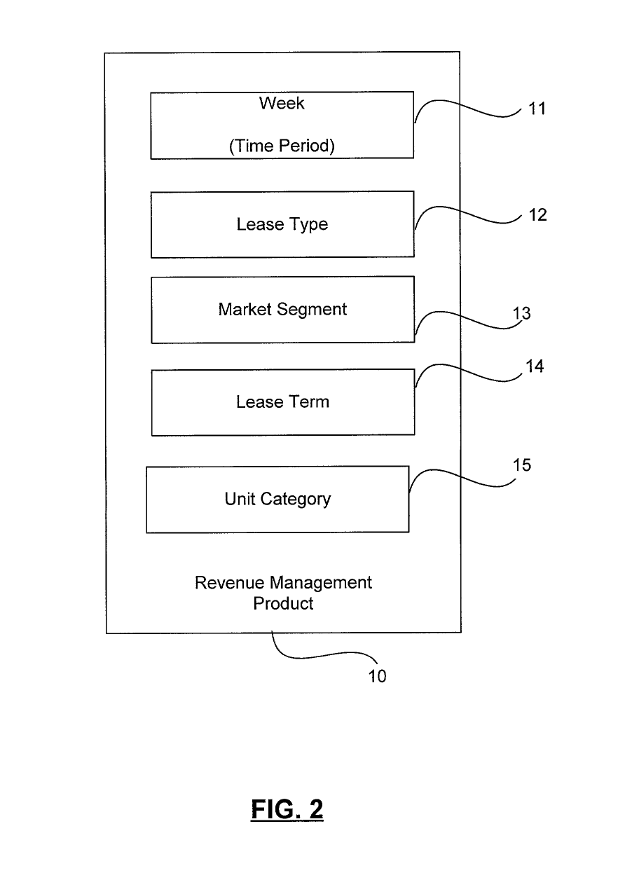

Every transaction may be bucketed into a RM product 10, which is defined by the following RM components as illustrated in FIG. 2:

1) Week 11;

2) Lease Type 12;

3) Market Segment 13;

4) Lease Term Category 14 and;

5) Unit Category 15.

While the system 100 works at the RM product level, the underlying data may be stored at greater detail levels (e.g., move-in date, market segment, lease term, unit type/number, etc.). Although RM products can be defined at the community level (i.e., defining the RM products differently for each different unit), it is preferable to standardize RM products, where possible, to assist in comparison reporting between different units.

Week 11 is the basic time period for which the forecast is made. Week 11 is the time period the customer moves in the rental property. Week has a start day and an end day. This period may be configurable through the back end, but defaults to each week starting on Monday and ending on Sunday. Alternatively, other time periods, such as hour, day, month or year, can be utilized in the present invention.

There are generally two lease types 12, New (N) and Renewal (R). Lease Types N and R have different price sensitivity behaviors. New customers tend to be more price-sensitive than renewals. In addition, “turndown” costs (i.e., opportunity costs) are greater for renewals to reflect the cost of moving out. These factors are monitored and automatically taken into account by various forecasting and optimization algorithms. In addition, demand forecasting for Lease Types N and R differs fundamentally. Lead times, lease terms, seasonality, and unconstrained de-seasonalized demand levels from the historical observations are considered to forecast demand for Lease Type N. However, forecast of expiring leases, renewal fractions, renewal fraction seasonality, and lease term fractions are used to forecast demand for Lease Type R. Each lease type may be further divided into various market segments by the user.

The lease term 14 is defined by the number of months the customer will stay in the unit. While the LRO 100 supports discrete lease term 14, it is preferable that lease terms be bucketed into Lease Term Categories (LTC), for example, a Short Term (1-3 months), a Mid Term (4-7 months), a Long Term (8+ months).

Unit Categories (UC) 15 are poolings of similar unit types. For example, unit categories may be defined by the number of bedrooms in the unit. The definition of unit categories are property-specific although it is desirable to define standard corporate types for comparing properties. The forecasting and optimization processes may consider all rooms within the UC as the same. In addition, demand may be forecasted separately for each UC 15. Also, the leases may then be optimized by UC.

Data Pooling Component 200

Returning to FIG. 1, the data pooling component 200 computes each statistic from a period of lease booking history. The user may specify the historical period or the period may be predetermined, step 1120 in FIG. 11. The history range for each statistic will be given in the backend by a minimum and maximum number of weeks (of the same type) to consider for pooling. The information may be gathered using known data collection and mining techniques. Subsequently, the Update Process 300 (described below) starts from the lowest dimension and shortest time range and updates the statistics by looking at the longer history first before it aggregates to higher levels.

Week type is one of the main keys by which Business Statistics are maintained. Since move-in and move-out activities significantly differ in each week of the month, the LRO 100 categorizes weeks based on the amount and type of the activity. The number of week types will be configurable by community in the system 100 based on how activity at a particular community is realized.

In one embodiment, a week starts on Monday and ends on Sunday. Week Type is identified by where its Saturday falls with respect to the month as: Week Type B (for Beginning) if the week includes the first Saturday of the month; Week Type E (for End) if the week includes the last Saturday of the month; and Week Type M (for Middle) otherwise. While this disclosure describes the use of weeks as the temporal period for records, it should be appreciated that other time units such as months, seasons, or years may be used without significant departure from the present invention.

In another embodiment, epoch points corresponds to the number of days before the Sunday (or endday) of the move-in week. They are used to construct lead time curves. The set of epoch points are dynamically determined based on the shape of the curve.

Business Statistics Update Module 300

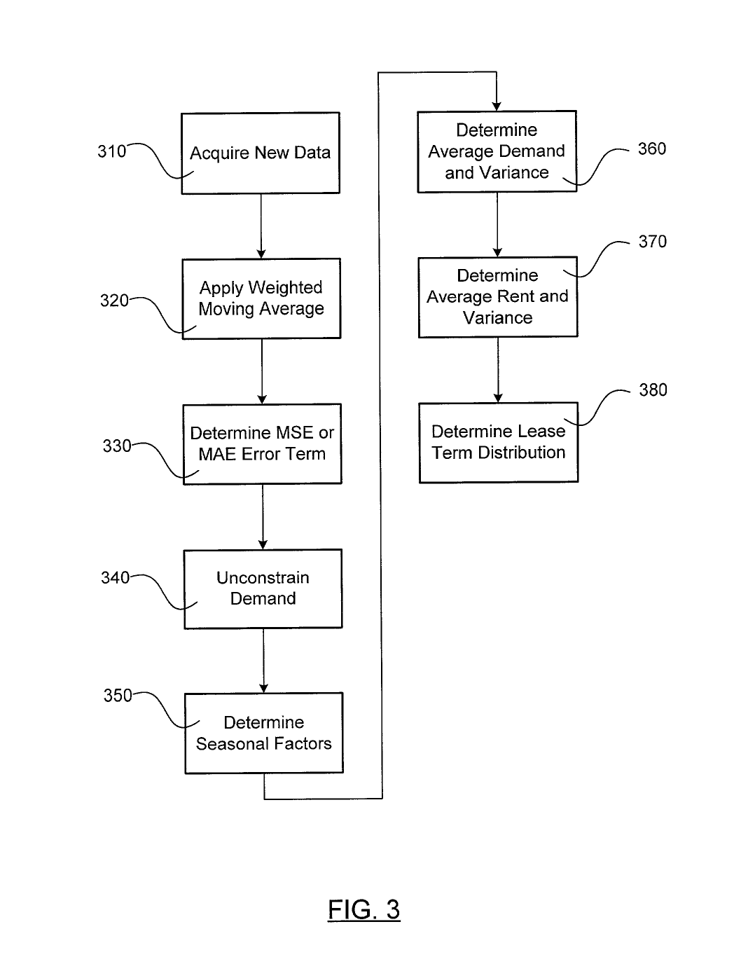

The Business Statistic Update Module (BSUM) 300 processes in periodic or random batch runs. The operation of the BSUM 300 summarized in FIG. 3. The BSUM 300 updates the collected data, step 1130 in FIG. 11. The BSUM 300 computes the values of Business Statistics to include results of the most current activity, step 310. Its primary objective is to keep all Business Statistics current.

The BSUM 300 starts following the execution of the Data Pooling Process 200 for each Business Statistic. Specifically, the BSUM 300 generally requires the Data Pooling Module 200 already identified the historical time period (H) and the pooling level at which updating takes place.

Preferably, the updating of each Business Statistic is based on Weighted Moving Average method step 320 with optimized weights to protect against extreme observations or “outliers.” Suppose that LRO 100 wish to forecast the next value of a statistic Yₜ, which is yet to be observed. Let the forecast be denoted by Fₜ. When the observation Yₜ becomes available, the forecast error is eₜ=Yₜ−Fₜ. The method of Weighted Moving Average takes the weighted average of past H observations to forecast for the next period as follows in equation 1:

$${F}_{o} = {\sum }_{t = 1}^{H} {a}_{ot} {Y}_{t} \qquad ( 1 )$$

where

$${\sum }_{t = 1}^{H} {a}_{ot} = 1 ,$$

and h=0 is assumed to be the next time period. The weight aₕₜ controls the extent to which the observation at time t influences the forecast of the statistic at time h.

BSUM 300 will compute optimal weight for each t and h in such a way that some global error criterion is minimized. LRO 100 will use a Leave-One-Out (or Cross Validation) method to choose optimal weights. The Leave-One-Out method omits the current period's observation and assumes that the estimate function is the weighted average of other observations in the historical time horizon under consideration. Then, a mean square error (MSE) or a mean average error (MAE) is computed, step 330. The weight function that minimize either MSE or MAE produces optimal weights. The user chooses whether MSE or MAE is used as global error criterion. A search for the optimal weight is then performed for a set of pre-specified smoothing (α) parameters.

Let h=0,1, . . . ,H be the time periods for which LRO 100 wants to compute the forecast. It is noted that when h=0, LRO 100 are interested in forecasting the next time period (i.e., equation 1). If t=3, for example, LRO 100 are computing forecast F₃ for the purpose of computing MSE and/or MAE. The weight function is a symmetrical function so that the most weight is given to the most recent observations. Let aₕₜ represent weight of observation at time t for the forecast at time period h. Then BSUM 300 assumes the following families of weight functions, which is denoted by aₕₜ for h=0, . . . ,H and t=1, . . . ,H:

$${a}_{ht} = \frac{{α}^{\vert t - h \vert}}{{\sum {α}^{\vert j - h \vert}}_{{j = 1}_{j \neq h}}} \qquad ( 2 )$$

where 0<α<1. It is noted that as α→1,

$${a}_{ht} -> \frac{1}{H}$$

when h=0; otherwise,

$${a}_{ht} -> \frac{1}{H - 1} ,$$

which is equivalent to the conventional moving average method. It is noted that if h=0, then LRO 100 gets the weights given in equation (1), which is for estimating the value of the statistic for the next time period. For given historical time period H and the aggregation level, LRO 100 will vary a within its bounds and find optimal α* in such a way that MSE or MAE is minimum.

To optimize weights by the Leave-Out-One method, the BSUM 300 will prespecify a set of α values and determine the optimum α* that minimizes MSE or MAE. The forecast of a given week h depends on the other weeks under the horizon H. In general, for the given value of α, the forecast of a given period h (h=0, . . . ,H) is computed by equation 3.

$${F}_{h} ( α ) = {{\sum }_{\begin{matrix}t = 1 \\ t \neq h\end{matrix}}}^{H} {a}_{ht} ( α ) {Y}_{t} \qquad ( 3 )$$

It is noted that LRO 100 leaves out the observation of period h for the purpose of computing the forecast for that period. A similar method is used to estimate density functions from the observations and often referred as Cross Validation Method, where the weight function is known as Kernel function. Then, the values of MSE(α) and MAE(α) can be computed as

$$\begin{matrix}MSE ( α ) = {\sum }_{i = 1}^{H} {( {Y}_{i} - {F}_{i} ( α ) )}^{2} \\ or & ( 4 ) \\ MAE ( α ) = {\sum }_{i = 1}^{H} \vert {Y}_{i} - {F}_{i} ( α ) \vert & ( 5 )\end{matrix}$$

Unconstraining is executed for new Lease Type N, step 340. Unconstrained historical demand is one of the main input to the weekly update process. Unconstrained demand represents all demand that would lease a property at the Reference Rent with no capacity limitations. Unconstrained demand is estimated by adding move-ins and turndowns, which can be rate or availability turndowns. BSUM 300 will utilize Guest Cards by Occupancy and Guest Card to Lease Ratio statistics to unconstrain demand for new customers, as explained below.

In one embodiment of BSUM 300, guest card statistics is used to perform unconstraining using the following equation:

$$Unconstrained Demand = Move\_ins + ( Number of Guest Cards - \\ Move\_ins ) * max ( 1 , \frac{{g}_{t} ( {u}_{t}^{′} = x \% )}{{g}_{t} ( {u}_{t} = actual )} ) * \\ Guest Card to Lease Ratio * \\ Guest Card Factor \qquad ( 6 )$$

where Guest Card Factor is a user-specified backend parameter; a regression equation is used to obtain Number of Guest Cards at Occupancy=x %; and the denominator in the second term pertains to actual occupancy.

In an optimal embodiment, the BSUM 300 further computes seasonal statistics, step 350. A first one is the Demand Seasonality, and a second one is the Renewal Fraction Seasonality. In this section, the focus is on the Demand Seasonality, which is automatically calculated with demand trend and special event factors. The Renewal Fraction Seasonality procedure is similar to the procedure presented in this section except that renewal trend and special event factors are not reported or stored and is discussed in greater detail below.

Seasonality refers to identical or almost identical patterns that demand appears to follow during corresponding weeks of successive years. Seasonality parameters provide an estimate of proportional, periodic deviations of demand from the underlying average demand. The LRO 100 generally maintains the seasonality parameters for Lease Type N only since the forecaster starts from the number of expiring leases for Lease Type R. Seasonality parameters are estimated simultaneously by regression models using at least one-year span of unconstrained observations. It is preferable that multiple year's observations are used to compute the seasonality parameters if data is available. This estimation process produces multiplicative seasonality factors used in the forecasting and optimization. Seasonality parameters are also used in the process of estimating deseasonalized demand during the Business Statistics update.

Final observations are inputted to the seasonality module. Seasonal factors are computed using a linear regression model, which assumes that the seasonal components are not changing year to year. The model uses a collection of dummy or indicator variables, each of which has only two allowable values, 0 or 1. A variable may correspond to a month, a week type, or a special event week. Seasonal factors, trend, and special event factors are computed simultaneously from the regression model.

The observed unconstrained demand is inputted to Demand Average computation. Observed Demand is then adjusted for seasonal variation and often referred as deseasonalized demand. Demand Average is about the size estimate of the demand. Demand Average is computed at the lowest pooling level and for the historical time period H that the user identifies in step 360. There is no need to perform Data Pooling for computing Demand Average and Demand Variance. The update module 300 first computes deseasonalized observed unconstrained demand for a historical time period H that the statistics will be based upon, using equation 7.

$${\tilde{Y}}_{t} = \frac{{Y}_{1}}{{SF}_{t}} for t = 1 , … , H \qquad ( 7 )$$

where Yₜ represents observed unconstrained demand, and SFₜ represents seasonality factor, and H represents number of historical weeks that are specified by the user (initially set to 8).

The BSUM 300 then computes Demand Average, step 360 continued, by employing a weighted moving average procedure computed by equation 8.

$${\overline{Y}}_{0} = {\sum }_{t = 1}^{H} {a}_{0 t} {\tilde{Y}}_{t} \qquad ( 8 )$$

where weight a₀ₜ is optimized as explained above. LRO 100 will represent user specified historical time period and optimal weights by H′ and aₜ^{′} for t=1, . . . , H′.

The degree to which historical demand tends to spread about its average is called “variance of demand.” This statistic measures if the data is tightly bunched together or spread across a wide range. In other words, variance is about the dispersion estimate of the demand. To determine the variance of demand, the BSUM 300 computes deseasonalized observed unconstrained demand for historical time period H using equation 7 for historical weeks that are used during Demand Average computation. The update module 300 then computes demand variance using equation 9.

$${s}_{y}^{2} = \frac{{H}^{′}}{{H}^{′} - 1} ( {\sum }_{t = 1}^{{H}^{′}} {a}_{0}^{′} {\tilde{Y}}_{t}^{2} - {( {\sum }_{t = 1}^{H} {a}_{0}^{′} {\tilde{Y}}_{t} )}^{2} ) \qquad ( 9 )$$

where weights a₀ₜ^{′} are obtained as described above and H′ is the number weeks used for the Demand Average computations. Thus, LRO 100 does not optimize for weights in the process of computing variance in this embodiment.

Rent Average is computed using monthly rents. It is used in Competitive Information Module 600 and Demand Elasticity Estimator 700. Ignoring Special Event weeks, the update module 300 computes historical time period H and aggregation level at which computation takes place using Data Pooling Process. Let this historical time period is denoted by H″. For the aggregation level identified at the Data Pooling Process, the update module 300 computes Rent Average for each week t=1, . . . ,H″ as

$${\hat{R}}_{1} = \frac{Total Revenue}{Total Lease Months} \qquad ( 10 )$$

The update module 300 then uses \hat{R}₁ instead of Yₜ and apply weighted moving average procedure to find the rent average as

$${\overline{R}}_{0} {= \sum }_{t = 1}^{{H}^{′}} {a}_{0 t} {\hat{R}}_{1} \qquad ( 11 )$$

where weights a₀ₜ are optimized for this statistic as described above.

The degree to which rents tend to spread about its average is called “variance of weekly revenue.” This statistic measures if the rent is tightly bunched together or spread across a wide range. Ignoring Special Event weeks, the update module 300 determines rent variance s_{y} as:

$${s}_{y}^{2} = \frac{{H}^{′′}}{{H}^{′′} - 1} ( {\sum }_{t = 1}^{{H}^{′′}} {a}_{0}^{′′} {\hat{R}}_{t}^{2} - {( {\sum }_{t = 1}^{{H}^{′′}} {a}_{0 t}^{′′} {\hat{R}}_{t} )}^{2} ) \qquad ( 12 )$$

where weights a₀ₜ^{″} is optimized and Rent Average determined as described above.

Lead time curves characterize arrival pattern by days left for Lease Type N. In other words, a lead time curve contains estimates of the fraction of total demand in new leases in the market segment that will be observed during various days. This statistic is about the shape estimate of demand across days, but not about the size estimate of the demand. The size and shape of the demand are estimated separately since they demonstrate different levels of stability. Generally, the demand fraction may be found using equation 13.

$$Demand Fraction ( EP = i ) = \frac{{\sum }_{DL > = i} Unconstrained Demand ( DL )}{{\sum }_{DL > = 0} Unconstrained Demand ( DL )} \qquad ( 13 )$$

where i represents an epoch point, and DL=WK(Sunday)−Capture Date. If a special event has occurred during the time period of interest, the update module applies a straight moving average of the past two or more years, subject to data availability.

Another variable managed by the update module 300 is a lease term distribution statistic representing the percentages of leases that fall within each LTC. Lease Terms are typically initially assigned to one of up to 3 lease categories based on the number of months representing short-term, medium length, and long-term leases. To determine the lease term distribution in step 380, the update module uses equations 14 and 15.

For LNR=N,

$$Lease Term Dist ( LTC = i ) = \frac{Unconstrained Demand ( LTC = i )}{Unconstrained Demand ( All )} ; \qquad ( 14 )$$

and for or LNR=R,

$$Lease Term Dist ( LTC = i ) = \frac{Move \text{-} Ins ( LTC = i )}{Move \text{-} Ins ( All )} \qquad ( 15 )$$

The update module 300 similarly determines Average Lease Terms, which are used in the optimization as expected lease term for the corresponding Lease Term Category. Specifically, the update module 300 uses equations 16a and 16b.

For LNR=N,

$$Average Lease Term ( LTC ) = \frac{{\sum }_{LTεLTC} Unconstrained Demand ( LT ) * LT}{{\sum }_{LTεLTC} Unconstrained Demand ( LT )} ; \qquad ( 16 a )$$

and for LNR=R,

$$Average Lease Term ( LTC ) = \frac{{\sum }_{LTεLTC} Move Ins ( LT ) * LT}{{\sum }_{LTεLTC} Move Ins ( LT )} \qquad ( 16 b )$$

where summation is over Lease Terms in the corresponding Lease Term Category and a weighted moving average method is applied.

An Early Termination Average represents total number of early termination counts, which are derived by incrementing the early terminations for each of the affected weeks (done at the aggregation). This statistic is based on the size estimate of early termination and focuses on the final (DL=0) early termination count. The LRO 100 may also form shape estimates of early termination, which derives a early termination lead time curve. Similarly, the Early Termination Lead Time Curve characterizes early terminations by days left. This statistic considers early terminations in both Lease Types N and R. It contains estimates of the fraction of early terminations that are observed during the various days. The update module calculates the Early Termination Demand Fractions as:

$$Early Termination Demand Fraction ( EP = i ) = \frac{{\sum }_{DL >= i} Early Termination ( DL ) }{{\sum }_{DL > = 0} Early Termination ( DL ) } \qquad ( 17 a )$$

while applying the weighted moving average method.

An average number of vacant days is derived from the difference between move-in and move-out dates of two consecutive leases. It is used to estimate expected vacancy cost, which is input to the optimization model. For every WK and Unit Category, the update module 300 considers the new lease and the previous lease move-out date. Let this difference be represented by Vacant Day (WT,UC), or

$$Average Vacant Day = \frac{{\sum }_{i} Vacant Day ( i )}{{\sum }_{i} 1} \qquad \text{(17b)}$$

where i represents observations (indexed to the new leases), and denominator represents total number of new leases.

“Renewal Fraction Seasonality” refers to identical or almost identical patterns that renewals appear to follow during corresponding weeks of successive years. Seasonality parameters provide estimate of proportional, periodic deviations of renewal fractions from the underlying average renewal fraction. The LRO 100 generally maintains the Renewal Fraction Seasonality parameters for Lease Type R only. Renewal Fraction Seasonality parameters are estimated simultaneously by regression models typically using at least one-year span of unconstrained observations. This estimation process produces multiplicative seasonality factors used in the forecasting and optimization.

Final observations of renewal fractions are inputted to this module. Seasonal factors are computed using linear regression model similar to the one used to estimate Demand Seasonality factors. The model utilizes a collection of dummy or indicator variables, each of which has only two allowable values, 0 or 1. A variable may correspond to a month, a week type, or a special event. The update module 300 also factors trends, but does not generally store them. The update component 300 performs fit the regression in equation 18. The form of the regression is

$${Y}_{1} \approx {a}_{0} + {a}_{1} t + {\sum }_{i = 1}^{11} {m}_{i} {X}_{i} + {\sum }_{j ∈ \{ B , M \}} {w}_{j} {Y}_{j} + {\sum }_{k = 1}^{K} {s}_{k} {Z}_{k} \qquad ( 18 )$$

The first term in equation 18 represents levels for the omitted Month and Week Type A month, and a week type (December and Week Type E) is omitted to avoid problem of multicollinearity (which is arbitrarily chosen to be December and Week Type E, this week is regarded as “base week.” “Base week” is the period for which all indicator variables have value zero. If some other period were chosen as the base week, the regression values would look different but still tell the same story. The second term is for a Trend component. The third summation term is for the 11 months, X₁ for January, X₂ for February, etc., and December is omitted because it was already counted in the first term. The fourth summation term is for week type with Week Type E being omitted. The last term is for special events. The coefficients associated with these variables reflect the average difference in the forecast variable between those weeks and the omitted week.

The update module 300 then computes Renewal Seasonality Constants for each month and week type using equation 19:

RSC(MT, WT)=â₀+\hat{m}_{MT}+ŵ_{WT} (19)

where â₀, \hat{m}_{MT}, and ŵ_{WT} are the coefficient estimates from the regression model. For each week type, the update module 300 normalizes the Seasonality Constants to their average (average of the seasonality constants) to find the Seasonality Factors.

Another statistic maintained by the update module 300 is Renewal Fraction. This statistic represents renewal fraction of existing leases. This statistic is used to forecast demand for Lease Type R. It is noted that this statistic has LTC dimension, which is keyed to the previous lease's LTC. Ignoring special event weeks, the Renewal Fraction as

$$Renewal Fraction = \frac{Renewals}{TotalNumberExpiringLeases} \qquad ( 20 )$$

Another variable maintained by the update module 300 is QOB. QOB results indicate that the number of guest cards depends on the occupancy level. Since during high rates of occupancy, demand requests are turned down for lack of availability, there is a significant correlation between occupancy and number of guest cards. The update module 300 first compute occupancy as

$$Occupancy = \frac{OnRent}{PhysicalCapacity - NonRevenue} \qquad ( 21 )$$

The LRO 100 may then use single variable regression to determine the effect of occupancy to the number of guest cards. The LRO 100 may use occupancy as independent variable and number of guest card as dependent variable. Another statistic maintained by the update module 300 is the Guest Card to lease ratio. This statistic monitors fraction of new customers leasing a unit after visiting or calling the property. The Guest Card to Lease Ratio may be found using equation 22.

$$Guest Card to Lease Ratio = \frac{Number of Move ins}{Number of Guest Cards} \qquad ( 22 )$$

To use equation 22, the update module 300 converts the leases and guest cards to the unit count level (i.e., remove the LTC dimension).

Demand Forecasting Module 400

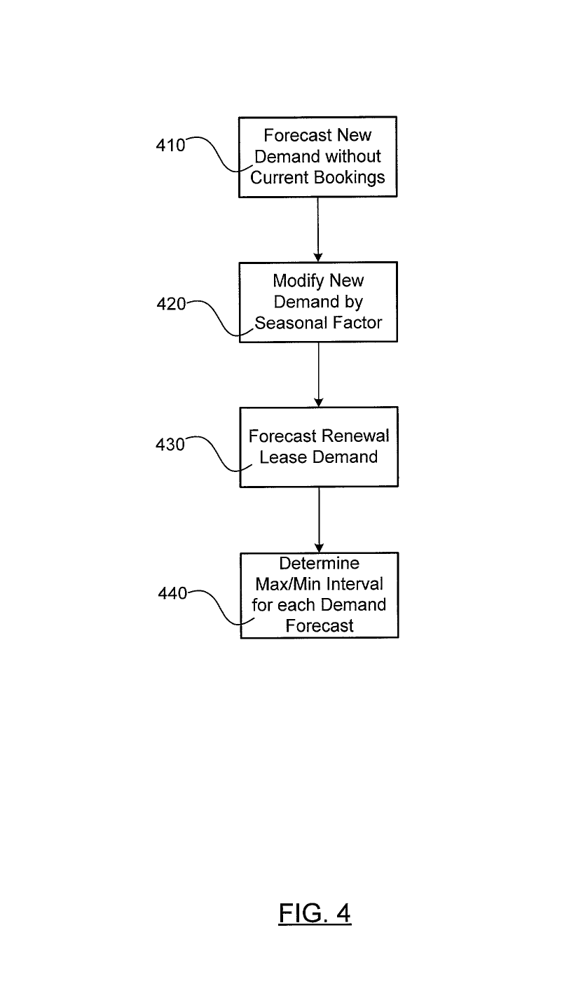

The Demand Forecasting Module (DFM) 400 forecasts unconstrained demand for Lease Type N and expected renewals for Lease Type R, step 1140 in FIG. 11. The operation of DFM 400 is summarized in FIG. 4. The DFM 400 outputs the data required by the report tables and input tables for the optimization process.

The DFM 400 forecasts Lease Type N and R in fundamentally different ways. The DFM 400 generally employs Year-Over-Year (YOY) and Bookings-Based demand forecasting models for Lease Type N. YOY forecasting uses the previous years' demand. based on multiple years' observation, subject to data availability. Bookings-based demand forecasting uses deseasonalized demand, seasonality, trend, lead time curves and lease term fractions from recent weeks' observations. On the other hand, the forecast for Lease Type R is derived from expected number of expiring leases, renewal fractions, renewal seasonalities, and lease term fractions.

All forecasts are floating point numbers.

Unconstrained demand is defined to be the total number of move-ins at the Reference Rent if there were sufficient units for all of them. As explained below, the LRO 100 helps implement optimal prices for the demand that has not yet leased using the unconstrained forecast of remaining demand.

Unconstrained demand forecast for Lease Type N is computed using Week, Unit Category, Lease Term Category, and Market Segment data. The forecaster for Lease Type N look to unconstrained deseasonalized demand, which includes denials and regrets, and excludes: (a) cancellations, (b) seasonality parameters, (c) trend parameters, (d) special event factor, (e) lead time curves (including special event lead time curves when applicable), and (f) lease term fractions. The DFM 400 begins with a forecast of total unconstrained demand without regard for the current bookings, in step 410. The deseasonalized arrival demand is multiplied by the seasonal factor in order to estimate the total number of move-ins, which would be expected for, a given week in a year, step 420. This is referred to as the long-term forecast because it can be performed prior to the move-in week when no added information about current bookings is available. For each WK, UC, LNR=N, MS:

$$\begin{matrix}Long Term Forecast = ( Deseasonalized Demand Average + \\ Trend * ( WK - Current Weekly ) ) * \\ Special Event Factor * \\ Seasonality Factor\end{matrix} \qquad ( 23 )$$

The DFM 400's forecast for Lease Type N is obtained by linear combination of booking based and YOY forecasts. By letting γε [0,1] be a user-specified parameter (in the backend) to represent the weight of booking based forecast. Then, for WK, UC, LTC, LNR=N, and MS:

$$\begin{matrix}LRO Remaining Demand Forecast = γ Booking Based \\ Demand Forecast + \\ ( 1 - γ ) YOY Remaining \\ Demand Forecast\end{matrix} \qquad ( 24 )$$

It is noted that this is executed for Lease Type N only.

The DFM 400 then forecasts demand for lease renewals using the number of expiring leases, step 450. The total number of expiring leases is equal to the current expiring leases plus remaining forecast of expiring leases, which is derived from the unconstrained remaining demand forecast. That is,

$$Total Expiring Leases ( WK , LTC , UC , MS ) = {\sum }_{LNR} Current Expiring Leases ( WK , UC , LTC , LNR , MS ) + Remaining Forecast of Expiring Leases ( WK , UC , LTC , LNR = N , MS ) \qquad ( 25 )$$

where Remaining Forecast of Expiring Leases is derived from Unconstrained Remaining Demand Forecast for new leases using equation 26.

$$Remaining Forecast of Expiring Leases ( WK , UC , LTC , LNR = N , MS ) = {\sum }_{t = 1}^{WK} ( {δ ( t , WK , UC , LTC , LNR = N , MS )}^{*} \\ Unconstrained Remaining Demand Forecast ( t , UC , LTC , LNR = N , MS ) ) \\ where δ ( t , WK , UC , LTC , LNR = N , MS ) = \{ \begin{matrix}1 & if [ t + {4}^{*} AveLT ( Wt , UC , LTC , LNR = N , MS ) ] = WK \\ 0 & otherwise\end{matrix} \qquad ( 26 )$$

It is noted that t=1 represents the next forecast period (week), and WK represents the week for which LRO would like to estimate number of expiring leases. An integer index is used (i.e., number of weeks from today) in the summation for WK. In addition, AveLT represents average lease term statistics in which WT is indexed to the t (not WK). Also, a denotes the smallest integer number greater than or equal to a.

Factors considered by the DFM 400 forecasts the Lease Type R includes: (a) total expiring leases, (b) current move-out notices, (c) renewal fraction, (d) seasonality of renewal fraction, and (e) lease term fraction. The forecast for Lease Type R may be based on the following formula:

$$Remaining Demand Forecast by old LTC = ( Total Forecast of Expiring Leases \text{-} Current move \text{-} out notices ) * Renewal Fraction * Renewal Fraction Seasonality \qquad ( 27 )$$

Subsequently, the LRO may compute Remaining Demand by existing LTC as:

$$Rem\_D \_By \_LTC ( WK , UC , LTC , LNR = R , MS ) = ( Total Expiring Leases ( WK , UC , LTC , MS ) - Current Move \text{-} out Notices ( WK , UC , LTC , MS ) -- Current Renewals ( WK , UC , LTC , LNR = R , MS ) ) * Renewal Fraction ( WK , UC , LTC , LNR = R , MS ) * Renewal Fraction Seasonality ( MT , WT , UC , LNR = R , MS ) \qquad ( 28 )$$

Furthermore, the LRO can aggregate over existing LTC using equation 29.

$$Rem\_D ( WK , UC , LNR = R , MS ) = {\sum }_{LTC} Rem\_D \_By \_LTC ( WK , UC , LTC , LNR = R , MS \qquad ( 29 )$$

The user may override of forecast if desired and no decaying applies. The DFM 400 populates the override at WK, UC, LTC, LNR, and MS levels. Forecasting works as if there was no override. However, optimization uses these override values for those combinations that have overrides, unless the values are removed.

The DFM 400 provides not only forecast values, but accompanying uncertainty statements, usually in the form of prediction intervals, step 440. This provides user worst and best case estimates and a sense of how dependable the forecast is. Forecasts cannot be expected to be perfect and intervals emphasize this. The prediction intervals are used in the process of simulating a sequence of realizations of demand and solving the optimization model to determine optimal rent recommendations. For each WK, UC, UTC, LNR, MS: the demand forecaster 400 may compute the difference Delta (Δ) as:

Δ=max{0.3 *Demand Forecast, \sqrt{DemandForecast}}.

The demand forecaster 400 computes Maximum Demand Forecast as follows:

Maximum Demand Forecast=Demand Forecast+Δ.

The demand forecaster 400 further computes Maximum Demand Forecast as:

Minimum Demand Forecast=max{Demand Forecast−Δ, 0).

In one embodiment of DFM 400, the initial horizon for the weekly process is optimization horizon (12 weeks) plus 56 weeks. That is, the forecast horizon is 68 weeks.

Supply Forecasting Module 500

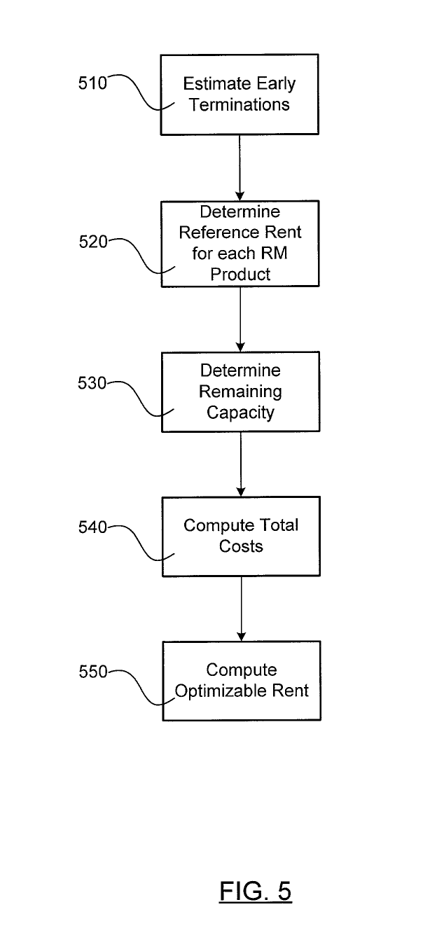

The optimization process uses a forecast of the remaining number of available units produced by the supply forecasting module (SFM) 500 in step 1150 of FIG. 11. The operation of SFM 500 is summarized in FIG. 5. The SFM 500 forecasts by Week and Unit Category, and includes physical capacity; on-rents; early termination average; early termination lead time curves; and non revenue (e.g., out of service) units.

It is noted that available Units are adjusted for Early Termination, which is the forecasted component of the supply. Early Termination Adjustment depends on the days left (Dl) to the end of the week. Days left is defined by the difference between End Date (i.e., Sunday) of the move-in week and current date.

Early Termination Adjustment, step 510, is computed as follows:

$$Early Termination Adjustment ( WK , UC , DL ) = Early Termination Average ( WK , UC ) * ( 1 - Early Termination Lead Time Fraction ( WK , UC , DL ) ) \qquad ( 30 )$$

For each WK, UC:

$$Optimizable Capacity ( WK , UC ) = Physical Capacity ( WK , UC ) - On Rents ( WK , UC ) - Nonrevenue Units ( WK , UC ) + Early Termination Average Adjustment ( WT , UC , DL ) \qquad ( 31 )$$

Optimizable Capacity is an input to the capacity constraints in the optimization model. Available Capacity by unit type is also needed for Action Index computation.

Available Capacity (WK, UT)=Physical Capacity (WK, UT)−On Rents (WK, UT)−Nonrevenue Units (WK, UT) (32)

The optimization process described below, uses a Optimizable Rent (Reference Rent minus property preparation and vacancy costs) as an input to produce optimal rents. The Competitive Information Module (CIM) 600 computes the Optimizable Rent using the client's own historical rents, competitor rents and user-entered parameters that define how much weight to give to each. This CIM 600 also computes a Reference Rent for each Week, Unit Type, Lease Term Category, Lease Type, and Market Segment. Because the horizon for competitor data is property-specific and related to the lead time curves, the reference rent is influence by competitor data within this period. For other weeks that are not in this period, the CIM 600 uses own historical data only. The LRO 100 may also have a staleness factor for competitive rents, but optimization ignores this. Staleness factor pertains to the number of days before a competitor's rent is flagged as old information. The stale information may then be either discounted or ignored.

Reference Rent pertains to “economic value” or perceived value of a unit in the marketplace. In general, the value of a product can be defined as the utility gained from it. It is assumed that customers compare Reference Rent to the offered rent of a unit. The LRO 100 computes Reference Rent at two levels. For display, it computes Reference Rent based on Current Base Effective Rent and competitor rents at WK, UT, LTC, LNR, and MS level. For optimization, the LRO 100 computes Optimizable Rent at WK, UC, LTC, LNR, MS level based on client's historical rents and competitor rents. This is computed as Reference Rent minus Property preparation and Vacancy Costs for each WK, UC, LTC, LNR, and MS level. This is one of the main inputs to the optimization model and represents net expected contribution.

The SFM 500 computes Reference Rent for each WK, UT, LTC, LNR, and MS, and then computes Reference Rent and then Optimizable Rent associated with each WK, UC, LTC, LNR, and MS, step 520. Specifically, the SFM 500 computes Market Base Rent Average in equation 33 as the weighted average of competitor base rents. For each UT and LTC:

$$Market Base Rent Average ( UT , LTC ) = {\sum }_{CP} [ CP Weight ( CP , UT ) * ( Monthly Base Rent ( CP , UT , LTC ) + CP Position ( CP , UT ) ] , where {\sum }_{CP} CP Weight ( CP , UT ) = 1. \qquad ( 33 )$$

The SFM 500 then computes Market Monthly Concession Average in equation 34 as the weighted average of competitor concessions divided by the Reference Month, which is available in the GUI on the competitor information screen.

$$Market Monthly Concession Average ( UT , LTC ) = \frac{{\sum }_{CP} CP Weight ( CP , UT ) * Concessions ( CP , UT , LTC )}{Reference Month ( LTC ) } \\ where {\sum }_{CP} CP Weight ( CP , UT ) = 1 \qquad ( 34 )$$

The SFM 500 may then compute Market Reference Rent as

$$Market Reference Rent ( UT , LTC ) = Market Base Rent Average ( UT ; LTC ) - Market Monthly Concession Average ( UT , LTC ) \qquad ( 35 )$$

Also, the supply forecasting computes Market Reference Rent by Lease Type and Market Segment according to equation 36:

$$Market Reference Rent ( UT , LTC , LNR , MS ) = Market Reference Rent ( UT , LTC ) + MSDifference ( UT , LNR , MS ) \qquad ( 36 )$$

where Market Reference Rent (UT, LTC) is obtained above in equation 35, and MSDifference(UT,LNR, MS) represents market segment difference, which is a backend parameter.

The SFM 500 may then computes Reference Rent at WK, UT, LTC, LNR levels. This Reference Rent is calculated as the Competitor influence weighted average of Current Base Effective Rent and Market Reference Rent.

$$Reference Rent ( WK , UT , LTC , LNR , MS ) = Market Reference Rent ( UT , LTC , LNR , MS ) * Competitive Influence ( UT ) + Current Base Effective Rent ( WK , UT , LTC , LNR , MS ) * ( 1 - Competitive Influence ( UT ) ) \qquad ( 37 )$$

This Reference Rent value is then used in Recommendations module 1000, as described below.

The SFM 500 then computes Remaining Capacity by WK and UT, step 530.

Rem Cap (WK, UT)=Physical Capacity (WK, UT)−On Rents (WK, UT)−Non revenue Units (WK, UT) (38)

It is noted that early termination adjustment is disregarded in equation 38.

The SFM 500 may then computes Market Reference Rent by WK, UC, LTC, LNR, and MS:

$$Market Reference Rent ( WK , UC , LTC , LNR , MS ) = \frac{\begin{matrix}{\sum }_{UT ∈ UC} Market Reference \\ Rent ( UT , LTC , LNR , MS ) * RemCap ( WK , UT )\end{matrix}}{( {\sum }_{UT ∈ UC} RemCap ( WK , UT ) )} \qquad ( 39 )$$

The SFM 500 then computes Competitive Influence by WK and UC.

$$Competitor Influence ( WK , UC ) = \\ \frac{{\sum }_{UTεUC} CompetitorInfluence ( UT ) * RemCap ( WK , UT ) }{{\sum }_{UTεUC} RemCap ( WK , UT )} \qquad ( 40 )$$

The SFM 500 then computes Reference Rent by WK,UC,LTC,LNR and MS according to equation 41.

$$Reference Rent ( WK , UC , LTC , LNR , MS ) = Market Reference Rent ( WK , UC , LTC , LNR , MS ) * Competitive Influence ( WK , UC ) + Rent Average ( WT , UC , LTC , LNR , MS ) ) * ( 1 - Competitive Influence ( WK , UT ) ) \qquad ( 41 )$$

This Reference Rent value may be stored, for instance, in a database. While Reference Rent is not directly used the system, but the Reference Rent is a central quantity that LRO should be able to access.

The SFM 500 then computes Reference Rent by WK, UC, and LTC level using equation 42:

$$Reference Rent ( WK , UC , LNR , = N ) = \frac{{\sum }_{LTC} {\sum }_{LNR} {\sum }_{MS} Ref Rent ( WK , LTC , LTC , LNR , = N , MS ) * Dmd Forecast ( WK , UC , LTC , LNR = N , MS ) }{{\sum }_{LTC} {\sum }_{LNR} {\sum }_{MS} Dmd Forecast ( WK , UC , LTC , LNR = N , MS )} \qquad ( 42 )$$

The SFM 500 then computes Property preparation Cost by WK, UC and LNR, step 540 using equation 43.

$$Make Ready Cost ( WK , UC , LNR ) = \\ \frac{{\sum }_{UTεUC} Make ReadyCost ( UT , LNR ) * RemCap ( WK , UT )}{{\sum }_{UTεUC} RemCap ( WK , UT )} \qquad ( 43 )$$

The SFM 500 may compute Total Monthly Cost by WK, UC and LNR, step 540. If LNR=N, the Total Monthly Cost is then defined by equation 44:

$$Total Monthly Cast ( WK , UC , LNR ) = ReferenceRent ( WK , UC , LNR ) * VacationDays ( WK , UC , LNR ) / 30 - MakeReadyCosts ( WK , UC , LNR ) \qquad ( 44 )$$

If LNR=R, the Total Monthly Cost is defined by equation 45:

Total Monthly Cost(WK,UC,LNR)=MakeReadyCost(WK,UC,LNR) (45)

Total Monthly Cost is used in the Recommendation module 1000 for adding Costs back to Optimum Rents, as described below.

The SFM 500 may Compute Optimizable Rent by WK, UC, LTC, LNR, and MS according to equation 46.

$$Optimizable Rent ( WK , UC , LTC , LNR , MS ) = Reference Rent ( WK , UC , LTC , LNR , MS ) * Reference Month ( LTC ) - Total Monthly Cost ( WK , UC , LNR ) \qquad ( 46 )$$

Optimizable Rent is an important statistic because it is one of the main inputs to the optimization in the optimization module 1000.

Competitive Information Module 600

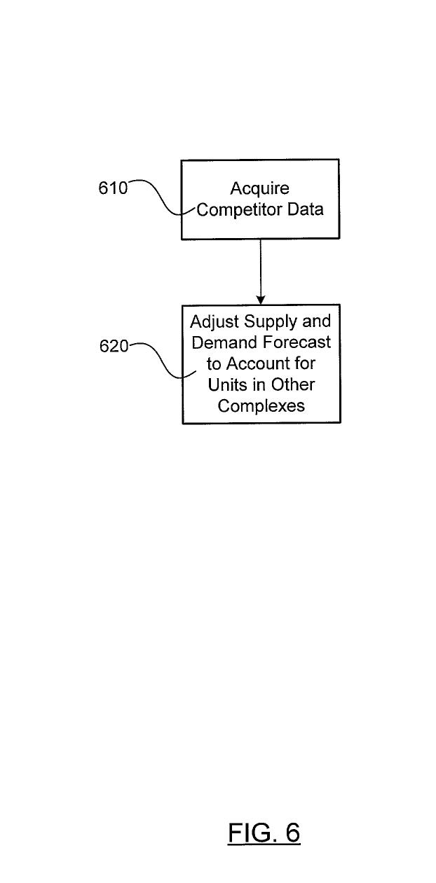

The competitive information module (CIM) 600 modifies the operation of the LRO 100 to account for competitors, step 1160 in FIG. 11. The operation of CIM 600 is summarized in FIG. 6. Specifically, the CIM 600 locates information on competing rental units, step 610 and uses this information as needed to alter supply/demand calculations as described above with DFM 400 and SFM 500, step 620. Known techniques used to gather the competitive information. For instance, automated crawlers may search for competitive information on the internet

Demand Elasticity Estimator 700

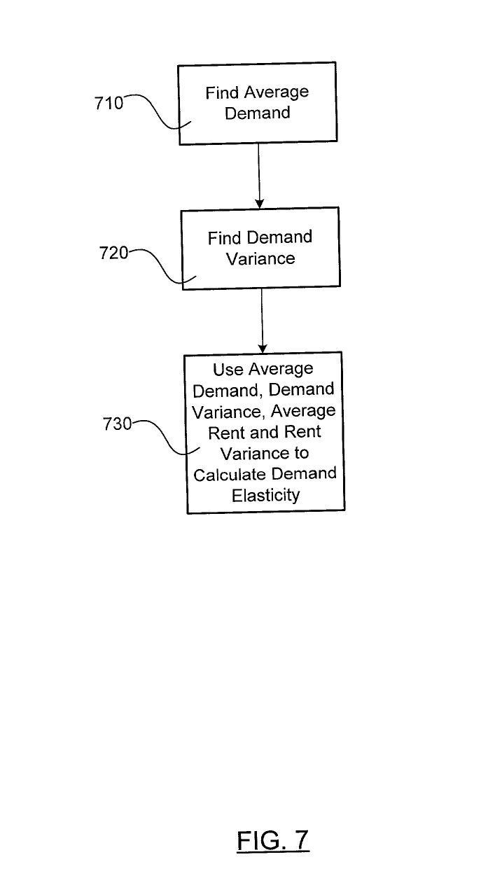

The demand elasticity estimator (DEE) 700 estimates demand elasticity, step 1170 in FIG. 11. The operation of DEE 700 is summarized in FIG. 7. The magnitude of change in demand in response to the change in rent depends on the demand elasticity. Demand elasticity is typically defined as the percentage change in demand versus the percentage change in price. The DEE 700 assumes an inverse relationship between price and demand; that is, DEE 700 defines elasticity to be the percentage decrease (increase) in demand versus the percentage increase (decrease) in price. As a result, elasticity is always negative.

An elasticity (β) model is defined to be

$$β = - \frac{\frac{Δ Y}{Y}}{\frac{Δ R}{R}} \qquad ( 47 )$$

where Y represents demand, R represents price (or rent), ΔY and ΔR denote differences in demand and price, respectively, and it is assumed that elasticity parameter β is constant for all rent R>0 and quantity Y>0.

In a preferred embodiment of the DEE 700, the following assumptions pertain to the demand elasticity:

1. A set of demand elasticity values (initially three of them) is pre-specified for each lease type. The final number used for each combination will be one of these values. This should be backend parameter.

2. Demand Elasticity is computed for each Week, Unit Category, Lease Term Category, Lease Type, and Market Segment;

3. Demand elasticity is assumed to be a function of historical variances of the price and demand. Specifically, the DEE 700 uses a ratio of coefficients of variation of quantity and price as an estimate of elasticity.

The process used by the DEE 700 to calculate demand elasticity value for each Week, Unit Category, Lease Term Category, Lease Type, and Market Segment in the forecast horizon is now described. The DEE 700 starts by computing Demand Average \overline{Y} step 70, and Demand Variance,

$$s \frac{2}{Y}$$

for each WK, UC, LTC, LNR=R. and MS as follows:

\overline{Y}=n*p (48A)

where, n is total expiring leases, p is a deseasonalized Renewal Fraction as described above, and

$$( s \frac{2}{Y} = n * p * ( 1 - p ) \qquad ( 48 B )$$

The DEE 700 then obtains data determined by the BSUM 300. In particular, the demand elasticity estimater 700 looks to Demand Average \overline{Y}, Demand Variance

$$s \frac{2}{Y} ,$$

Rent Average R, and Rent Variance

$$s \frac{2}{R} ,$$

which all are computed at WT, UC, LTC, and MS.

Demand elasticity value is then estimated as a function of historical variances of the rent and demand using equation 48, step 730.

$$β = - \frac{max ( \frac{{S}_{\overline{Y}}}{\overline{Y}} , min CV )}{max ( \frac{{S}_{\overline{Y}}}{\overline{R}} , min CV )} \qquad ( 49 )$$

where \overline{Y}, s_{\overline{Y}}, \overline{R}, and s_{\overline{R}}, are at WT, UC LTC, LNR, and MS. The minimum coefficient of variation (min CV) is a backend parameter. Each of the variables WT, UC, LTC, LNR, and MS, points to one of the pre-determined elasticity values based on the value of β. For instance

if β<a, then β=β_{1′}

if β≧a and β≦b, then β=β₂

else β=β₃

where a, b, β₁, β₂ and β₃ are backend parameters. Notice that b, β₁, β₂ and β₃ are by Lease Type.

Optimization Module 800

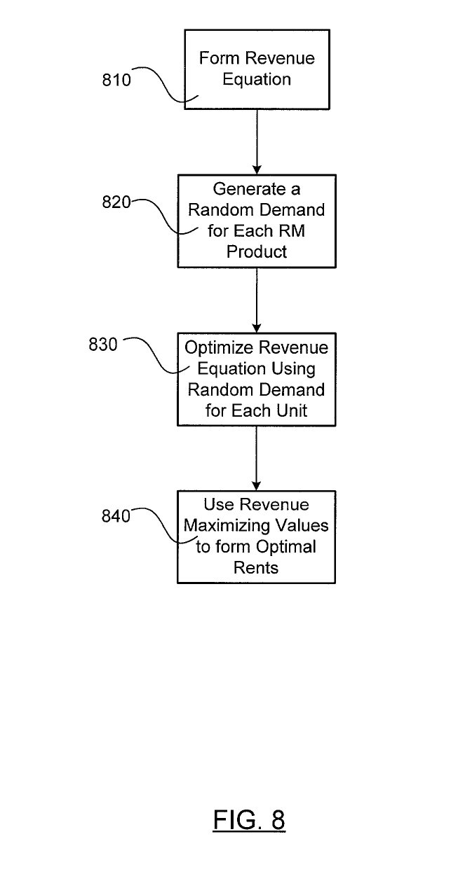

The optimization module (OM) 800 produces an optimal rent, step 1180 in FIG. 11. The operation of the OM 800 is summarized in FIG. 8. The OM 800 is activated generally on a intermitent basis, such as nightly. The optimization horizon is a system parameter and may initially be set to 12 weeks. The OM 800 uses demand forecast, optimizable capacity, optimizable rent, demand elasticity, and upgrade hierarchy to compute optimal rents and constrained forecast for each WK, UC, LTC, LRN, and MS. Rents should be re-optimized after making any changes to the input to the model.

The optimization model is a concave quadratic maximization problem in which all constraints are linear. The method consists of simulating a sequence of realizations of demand between prediction intervals and solving the deterministic quadratic programming model. The optimal prices from this sequence is then averaged to form optimal price recommendations.

The application first introduce the notational indices used in defining the Decision variables

$$\begin{matrix}t & week \\ c & unit category \\ j & lease term category \\ h & lease type \\ i & market segment\end{matrix}$$

Decision variables in the optimization module 800 include

Q_{tcjni} optimum quantity (or allocation) for week t, unit category c, lease term category j, lease type n, market segment i

P_{tcjni} optimum price for week t, unit category c, lease term category j, lease type n, market segment i

P_{tcjni} is not directly used in the optimization. It is part of the post optimization process and derived from Q_{tcjni}.

Parameters for Optimize module 700, include:

P_{tcjni}^{R} Optimizable Rent for week t, unit category c, lease term category j, lease type n, market segment i

Q_{tcjni}^{R} unconstrained demand forecast for week t, unit category c, lease term category j, lease type n, market segment i. This may also represent a realization of demand during the simulation process.

R_{tcjni} revenue associated with week t, unit category c, lease term category j, lease type n, market segment i

β_{tcjni} demand elasticity parameter for week t, unit category c, lease term category j, lease type n, market segment i

C_{tc} Optimizable Capacity for week t and unit category c

C_{tc}^{′} Capacity after considering the hierarchy.

$${δ}_{dtcjni} = \{ \begin{matrix}1 & if ⌈ d + 4 * max \{ AveLT ( d , c , j , n , i ) , MinMonth ( j ) , 1 \} ⌉ > t \\ 0 & otherwise\end{matrix}$$

where 1≦d≦t. In addition, Average Lease Term Statistic is computed from the week type of week d. MinMonth(j) is equal to minimum number of months for a given lease term category. It is noted that minimum number of months for the shortest lease term category should be 1. That is why the term is always equal to 1 in case minimum month for the shortest lease term category is defined as 0.

Furthermore,

$${δ}_{dtcjni} = \{ \begin{matrix}1 & if LTC j arriving on week d occupies a unit on week t \\ 0 & otherwise\end{matrix} \qquad ( 50 )$$

and J is the maximum number of lease term categories.

The relationship between Demand and Price may be assumed to be linear. Specifically, LRO may use

P=β(Q−Q^{R})+P^{R} (51)

where

P=price

β=elasticity parameter (β<0)

Q=demand

Q^{R}=reference demand (i.e., forecast of demand or realization of demand in the simulation)

P^{R}=optimizable rent

In addition, LRO may assume that an upper price, P^{U}, is equal to

P^{U}=P^{R}+β(−Q^{R}) (52)

where P^{U}≧P^{R} since β<0. System parameter defines the lower price P^{L}, which could be a percent off the P^{R}. The upper price P^{U} is such that demand is equal to zero.

If LRO sets P=P^{L}, LRO obtains Q^{U} as follows in equation 53.

$${Q}^{U} = \frac{{P}^{L} + β {Q}^{R} - {P}^{R}}{β} \qquad ( 53 )$$

where β, Q^{R}, P^{R}, P^{L} are known.

If Q is an independent variable.

R=(β(Q−Q^{R})+P^{R})Q (54)a,

which can be rewritten as

R=βQ²+(P^{R}−βQ^{R})Q (54)b.

Accordingly, the second derivative is

$$\frac{{\partial }^{2} R}{\partial {Q}^{2}} = 2 β \qquad ( 55 )$$

and for β<0, revenue function is concave.

Thus, OM 800 can use concave quadratic maximization model. This quadratic program is a separable problem; that is, only the diagonal terms of the matrix of objective function coefficients is defined. In addition, the matrix is negative definite.

The solution algorithm formed in step 810 is generally expressed in equations 56-58.

$$\begin{matrix}max {\sum }_{t} {\sum }_{c} {\sum }_{j} {\sum }_{n} {\sum }_{i} {β}_{tcjni} {Q}_{tcjni}^{2} \pm {\sum }_{t} {\sum }_{c} {\sum }_{j} {\sum }_{n} {\sum }_{i} ( {P}_{tcjni}^{R} - {β}_{tcjni} {Q}_{tcjni}^{R} ) {Q}_{tcjni} & ( 56 ) \\ {\sum }_{d = 1}^{t} {\sum }_{j = 1}^{J} {\sum }_{n} {\sum }_{i} {δ}_{dtcjni} {Q}_{dcjni} \leq {C}^{ ∀ t , c} & ( 57 ) \\ O \leq {Q}_{tcjni} \leq {Q}_{tcjni}^{R} ∀ t , c , j , n , i & ( 58 )\end{matrix}$$

solves equations 56-58 using Q^{R}=Demand Forecast to produce a Constrained Forecast by WK, UC, LTC, LNR and MS, which is optimal quantity Q*_{tcjni} obtained directly from the solution vector. Then, for each WK, UC, LTC, LNR and MS, the optimizer 800 computes optimal rent step 830 as follows:

$${P}_{tcjni}^{*} ( k ) = {β}_{tcjni} ( {Q}_{tcjni}^{*} ( k ) - {Q}_{tcjni}^{R} ( k ) ) + {P}_{tcjni}^{R} \qquad ( 59 )$$

where k represents k^{th} iteration. The OM 800 stores this optimal rents as P*_{tcjni} (0), representing the first set of rent recommendations based on the forecast (i.e., based on the mode).

The optimizer repeatedly increments k until K>N, where N is the system parameter specifying number of iterations in the simulation. For every new k value and for each combination of WK, UC, LTC, LNR and MS, the OM 800 considers Minimum Demand Forecast (a), Maximum Demand Forecast (c), and Q^{R} (b) in a triangular distribution and generates 100 a random demand. In this way, the OM 800 generates random demand for all possible combinations of WK, UC, LTC, LNR, and MS before solving the optimization model, step 820. For each value of k, the OM 800 uses these random demands and re-solve model (5)-(7) to obtain next set of optimal rent recommendations by replacing Q^{R} with the random demands in the model to change the objective function and upper bounds of variables.

The OM 800 then computes P*_{tcjni} (k) based on equation 59. Q_{ce} k's K, then the optimizer produces P*_{tcjni} using equation 60, step 840.

$${\overline{{P}^{*}}}_{tcjni} = \frac{{\sum }_{k = 0}^{K} {P}_{tcjni}^{*} ( k )}{K + 1} \qquad ( 60 )$$

\overline{P*}_{tcjni} is the final rent recommendation for each WK, UC, LTC, LNR and MS.

Constrained Demand Forecasting Module 900

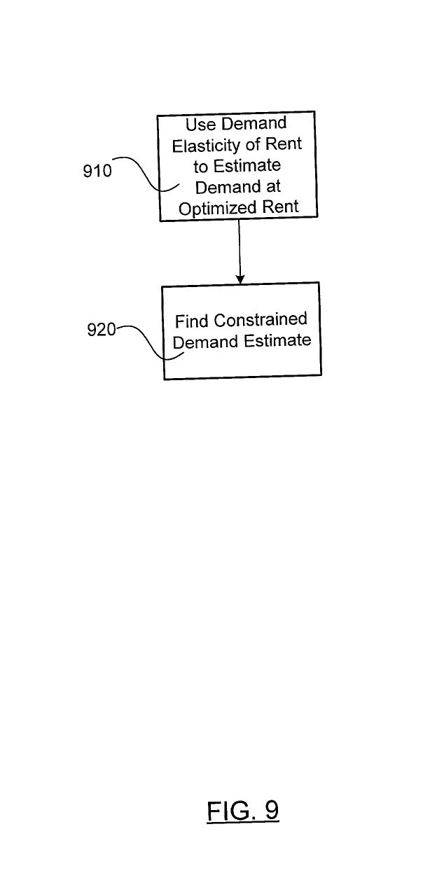

The constrained demand forecasting module (CDFM) 900 forms an estimate of demand that is to be accepted from the outputs of the OM 800, step 1190 in FIG. 11. The operation of the CDFM 900 is summarized in FIG. 9. Remaining constrained demand forecast is based on the output of the optimization model with Q^{R} equal to the demand forecast. The CDFM 900 mars shows constrained forecast at two levels. The first level is at the WK, UC, LTC, LNR, and MS and is a direct output (Q*_{tcjni}) from the optimization. The second level is at WK, UC, LNR, and MS, and should be computed based on the constrained forecasts (Q*_{tcjni}) and allocated to units over the weeks according to the average lease terms to produce the forecasts of constrained units sold. That is,

$$remaining Constrained Forecast ( t , c , n , i ) = {\sum }_{d = 1}^{t} {\sum }_{j = 1}^{J} {δ}_{dtcjni} {Q}_{tcjni}^{*} \\ where \\ {δ}_{dtcjni} = \{ \begin{matrix}1 if [ d + 4 * AveLT ( Wt , UC , LTC , LNR , MS ) ] \geq t \\ 0 otherwise\end{matrix} \qquad ( 61 )$$

and all constrained forecasts are preferably converted to integers and reconciled to ensure that they balance.

Recommendation Module 1000

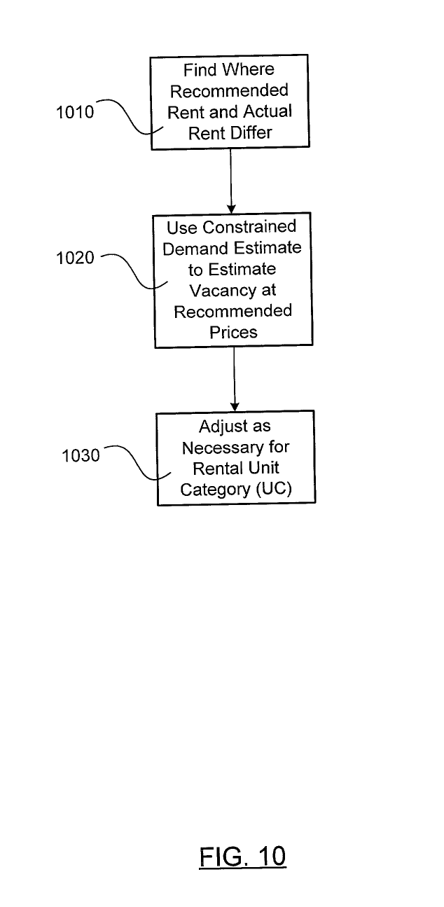

The recommendation module (RM) 1000 recommends an optimal rent for each Week, Unit Type, Lease Term Category, Lease Type, and Market Segment, step 1195 in FIG. 11. The operation of RM 1000 is summarized in FIG. 10. Recommendations generally are only produced when the current rents differ from the optimal rents.

In the CIM 600, total monthly cost including Vacancy and Property preparation Costs, is deducted from the Reference Rent. As a result, the OM 800 produces optimum rents net of costs, and it is necessary to add this cost back. The optimum rent with costs added by Optimum CRent is determined by the RM 1000 using equation 62.

$$Optimum CRent ( WK , UC , LTC , LNR , MS ) = Optimum Rent ( WK , UC , LTC , LNR , MS ) + Total Monthly Cost ( WK , UC , LNR ) \qquad ( 62 )$$

The optimization produces recommendations at WK, UC, LTC, LNR, and MS level. This is converted into WK, UT, LTC, LNR, and MS level by using relationships among Current Base Effective Rents. Further, recommendations are converted into WK, UT, LT, LNR, and MS level using the relationships among the expected number of empty units for each week that falls into the corresponding lease term category.

The recommendation module first computes Current Base Effective Rent using equation 63.

$$Current Base Effective Rent ( WK , UC , LTC , LNR , MS ) = Current Base Rent ( WK , UC , LTC , LNR , MS ) - [ Current Concessions ( WK , UC , LTC , LNR , MS ) ] / Reference Month ( LTC ) \qquad ( 63 )$$

The recommendation module 1060 then computes Optimal CRent (WK, UT, LTC, LNR, MS) using equation 64:

$$Optimal CRent ( WK , UC , LTC , LNR , MS ) = Optimum CRent ( WK , UC , LTC , LNR , MS ) * [ Current Base Effective Rent ( WK , UC , LTC , LNR , MS ) * {Σ}_{UTεUC} 1 ] {Σ}_{UTεUC} [ Current Base Effective Rent ( WK , UC , LTC , LNR , MS ) ] \qquad ( 64 )$$

where UT belongs to UC and Σl denotes number of UTs within a given UC.

UTεUC

The RM 1000 next computes Remaining Constrained Forecast at WK and UC level using equation 65.

$$R emaining Constrained Forecast ( WK , UC ) = {Σ}_{LNR} {Σ}_{ MS} R emaining Constrained Forecast ( WK , UC , LNR , MS ) \qquad ( 65 )$$

where Remaining Constrained Forecast (WK, UC, LNR, MS) is found with the Constrained Demand Forecasting module 900.

The recommendation module 1000 can now compute Empty Unit Forecast (WK, UC) as:

$$Empty Unit Forcast ( WK , UC ) = max \{ 0 , Optimizable Capacity ( WK , UC ) - Remaining Constrained Forecast ( WK , UC ) \} \qquad ( 66 )$$

The recommendation module 1000 can now compute Average Empty Unit Forecast by WK, UC and LT, using equation 67.

$$Average Empty Unit Forecast ( WK , UC , LT ) = \frac{1}{4} * {\sum }_{t = WK + 4 LT - 4}^{WK + 4 LT - 1} [ Empty Unit Forecast ( t , UC ) ] \qquad ( 67 )$$

The recommendation module 1000 may then compute Average Empty Unit Forecast by WK, UC and LTC.

$$Average Empty Unit Forecast ( WK , UC , LT ) = {Σ}_{LTεLTC} [ Empty Unit Forecast ( WK , UC , LT ) ] / {Σ ( 1 )}_{LTεLTC} \qquad ( 68 )$$

where

$${Σ1}_{LTεLTC}$$

denotes the number of LT within LTC.

The recommendation module 1000 may then compute LT Empty Unit Ratio by WK, LT, LTC.

$$LT Empty Unit Ratio ( WK , LT , LTC ) = [ Empty Unit Forecast ( WK , UC , LTC ) ] / Empty [ Unit Forecast ( WK , UC , LTC ) ] \qquad ( 69 )$$

The recommendation module 1000 may then compute Optimum CRent by WK, UT, LT, LNR, MS, where

$$Optimum CRent ( WK , UC , LT , LNR , MS ) = Optimum CRent ( WK , UC , LTC , LNR , MS ) * LT Rent Ratio ( WK , LT , LTC ) \qquad ( 70 )$$

All optimal rents are checked against current rents by each WK, UT, LT, LNR and MS. Only those that differ are identified as new recommendations. If an optimum rent differs from the current rent for each combination by a Rent Threshold (this has a min and max by WK), the recommendations are created. Rent Threshold is specified by the user and can be percentage or dollar amount.

In one embodiment, the LRO 100 monitors forecast performance. This is implemented through the Forecast Performance report. It provides measures of the demand forecast compared to the actual bookings, denials and regrets. This report permits tracking the performance of the forecasters over the booking history of any selected weeks.

In another embodiment, the user influences on forecast and optimum rent. In particular, the user is allowed to make adjustments to the forecast and optimal rents.

The foregoing description of the preferred embodiments of the invention has been presented for the purposes of illustration and description. It is not intended to be exhaustive or to limit the invention to the precise form disclosed. Many modifications and variations are possible in light of the above teaching. For instance, the method of the present invention may be modified as needed to incorporate new communication networks and protocols as they are developed. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed:

1. A method for recommending a rent for a lease, the method comprising the steps of:
organizing the lease by its a revenue management (RM) product;
gathering historical data for that RM product;
forecasting demand for the RM product using said historical data;
forecasting supply for the RM product using said historical data;
estimating demand elasticity for the RM product using historical said data; and
identifying an optimizing rent using said forecasted demand, said forecasted supply, and said estimated demand elasticity.

2. The method of claim 1, wherein said factors in said RM product include a time period, a lease type, a market segment, a lease term category, and a unit category.

3. The method of claim 2, wherein said lease type is either new or renewal.

4. The method of claim 2, wherein said lease term is either short, medium, or long.

5. The method of claim 1, wherein a user designates a time interval during which said historical data is collected.

6. The method of claim 1 further comprising the step of updating the historical data to include new data.

7. The method of claim 6, wherein said updating uses a weighted moving average.

8. The method of claim 7, wherein the updating uses a leave-out-one method to choose said weights.

9. The method of claim 6, wherein said updating uses an error term.

10. The method of claim 9, wherein said error term is a mean-squared error or a mean-average error.

11. The method of claim 1, wherein said step of gathering historical data further includes unconstraining said historical data.

12. The method of claim 1, wherein said step of gathering historical data further includes:
determining a seasonality factor, and
adjusting said historical data by said seasonality factor.

13. The method of claim 1, wherein said step of forecasting demand includes forecasting new lease demand.

14. The method of claim 1, wherein said step of forecasting demand includes forecasting renewal lease demand.

15. The method of claim 14, wherein said renewal lease demand is estimated using a number of times the lease will expire within a time period.

16. The method of claim 1, wherein said demand forecasting produces a range having a maximum forecasted demand and a minimum forecasted demand.

17. The method of claim 1, wherein supply forecasting includes forecasting the number of early terminations.

18. The method of claim 1 further comprising the step of computing a reference rent corresponding to a perceived value for a unit associated with the lease.

19. The method of claim 1 further comprising the steps of:
collecting competitor data; and
adjusting forecasted supply and demand for said competitor data.

20. The method of claim 1, wherein estimating demand elasticity uses an average rent, an average demand, a variance of rent, and a variance of demand.

21. The method of claim 1, wherein the optimized rent is identified includes:
forming a revenue function for said lease using said forecasted demand, forecasted supply, and said estimated demand elasticity; and
finding a maximum value for said revenue function.

22. The method of claim 1 further comprising the step of using the demand forecast and the estimated demand elasticity to estimate demand at the optimal rent.

23. The method of claim 22 further comprising the step constraining the estimated demand at the optimal rent.

24. The method of claim 23 wherein said optimum rent is adjusted for the constrained demand.

25. A system for optimizing a rent for a unit over a time period, the system comprising:
a data pooling module for collecting information on the unit and related units;
a demand forecaster for the unit and related units over the time period;
a supply forecaster for the unit and related units over the time period;
a demand elasticity module for the unit and related units over the time period; and
an optimization module using the demand forecaster, the supply forecaster and the demand elasticity module for determining the optimal rent of the unit over the time period.

26. The system of claim 25 further comprising a statistical update module for modifying the data pooling module with new data.

27. The system of claim 25 further comprising a competitive information module for modifying the demand forecaster, the supply forecaster, and the demand elasticity module using competitor data.

28. The system of claim 25 further comprising a constrained demand forecaster for estimating constrained demand at the optimal rent produced by the optimizer module.

29. The system of claim 28 further comprising a recommendation module for modifying the optimal rent in view of the estimated constrained demand.

30. A system for optimizing a rent for a lease, the system comprising:
a means for collecting information;
a means for demand forecasting;
a means for supply forecasting;
a means for estimating demand elasticity; and
a means for using the demand forecast, the supply forecast and the estimated demand elasticity to determine the optimal rent.
